(19) United States
(12) Patent Application Publication
(10) Pub. No.: US 2007/0088464 A1
(43) Pub. Date: Apr. 19, 2007

(54) Apparatus and method for inter-vehicle communication

(76) Inventor: Keven D. Coates, Cypress, TX (US)

Correspondence Address: TEXAS INSTRUMENTS INCORPORATED, P O BOX 655474, M/S 3999, DALLAS, TX, 75265, US

(21) Appl. No.: 11/249,222

(22) Filed: Oct. 13, 2005

(51) Int. Cl. G06F 19/00

(52) U.S. Cl. 701/1; 701/117

(57) ABSTRACT

An inter-vehicle communication system provides the ability to propagate signal groups along lanes of traffic and between lanes of traffic. Each vehicle includes a user interface that permits the driver of vehicle to send messages and to receive messages, the messages generally referring to traffic conditions. In this manner, drivers in traffic pattern can be made aware of traffic conditions that are remote from the vehicle and can take appropriate, timely action.

### BACKGROUND OF THE INVENTION

1. Field of the Invention

This invention relates generally to motor vehicles and, more particularly, to the communication of local traffic-related conditions to surrounding vehicles.

2. Background of the Invention

The highway system has been unable to keep pace with the ever-increasing number of vehicles and with the movement of much of the population to the suburbs. New highways are frequently already inadequate for the traffic load upon, completion. The increase in traffic, in addition to the resulting frustration, has provided a dangerous situation. High speed and dense traffic conditions in with vehicles of varying size, ranging from tractor trailers to compact cars, provide a dangerous scenario. In fact the scenario is so dangerous that automobile manufacturers have spent considerable resources both in the use of inflatable bags and in designing frames that will crumble in an accident in a manner to permit minimum impact on the occupants of the vehicle. While these efforts have successful, the differential in the sizes of the vehicles and the possibility of nearly simultaneous front-end and rear-end collisions, (the so-called pile-up) reduce the effectiveness of these efforts.

The high-speed dense traffic has made certain weather conditions particularly dangerous. Black ice, fog, intense rainstorms, and dust storms inhibit the ability of a driver of the vehicle to have adequate time to react to developing danger.

One attempt to address this class of problems has included more visibly prominent rear lights. The prominence can be enhanced by the positioning or by increased illumination intensity, rear lights. This technique attempts to alert a following vehicle in such a manner as to permit a response to a rapidly changing traffic situation. In addition, one strategy has been suggested wherein the rear lights indicate when the driver of the forward vehicle has removed his foot from the accelerator. In either case, the additional time gained by such features has not provided a significant amount of time to avoid an accident especially in view of the reaction time of the driver.

Another technique for addressing the problem of high speed, high density highway conditions, has been to install a Doppler device on the forward part of a vehicle. The Doppler device can monitor the relative speed between the vehicle in which the device has been installed and the next vehicle. While this information is helpful, when the both vehicles have already started closing, the opportunity for effective response may have already been lost, particularly when the reaction time is considered.

A need has therefore been felt for apparatus and an associated method having the feature of providing improved communication between motor vehicles. It would be a more particular feature of the apparatus and associated method to provide communication between vehicles in a traffic lane. It would be yet another feature of the apparatus and associated method to provide an inter-vehicle communication permitting the warning of distant traffic conditions. It would be a still further feature of the apparatus and associated method to alert the drivers of vehicles in a traffic stream to remote traffic conditions. It would be yet a further feature of the apparatus and associated method to permit a user of a vehicle to input to an inter-vehicle communication system traffic conditions that may be of interest to vehicle users in the traffic lane having the conditions It would be still a further feature of the apparatus and associated method to provide information concerning remote traffic conditions to permit the vehicle user to anticipate and/or avoid traffic problems that are still remote relative to the vehicle.

### SUMMARY OF THE INVENTION

The foregoing and other features are accomplished, according the present invention, by providing each vehicle with a signal receiving/transmitting array in the front and back of the vehicle. The two arrays are coupled such that a first array receiving a signal from a nearby vehicle transfers the signal to the second array where it is transferred to the next vehicle. Thus, a signal set is transferred from vehicle to vehicle in line of traffic. In addition, each vehicle has a user interface that permits the user to receive and interpret the signals and/or generate signals. With the information provided by the inter-vehicle communication system, the vehicle driver can initiate a timely and appropriate response. Thus, a signal concerning traffic or other conditions can be entered and communicated to each vehicle in a line of vehicles. Furthermore, two arrays can be placed on either side of the vehicle permitting two lanes of traffic to provide information concerning relevant traffic conditions in the other lane.

Other features and advantages of present invention will be more clearly understood upon reading of the following description and the accompanying drawings and the claims.

### BRIEF DESCRIPTION OF THE DRAWINGS

FIG. 1 illustrates the inter-vehicle communication system according to the present invention.

FIG. 2 illustrates an additional configuration for inter vehicle communication system for communicating between vehicles traveling parallel to, but not in the same lane of traffic, according to the present invention.

FIG. 3 is a block diagram of the components implementing the inter-vehicle communication system of each vehicle according to the present invention.

### 1. DETAILED DESCRIPTION OF THE FIGURES

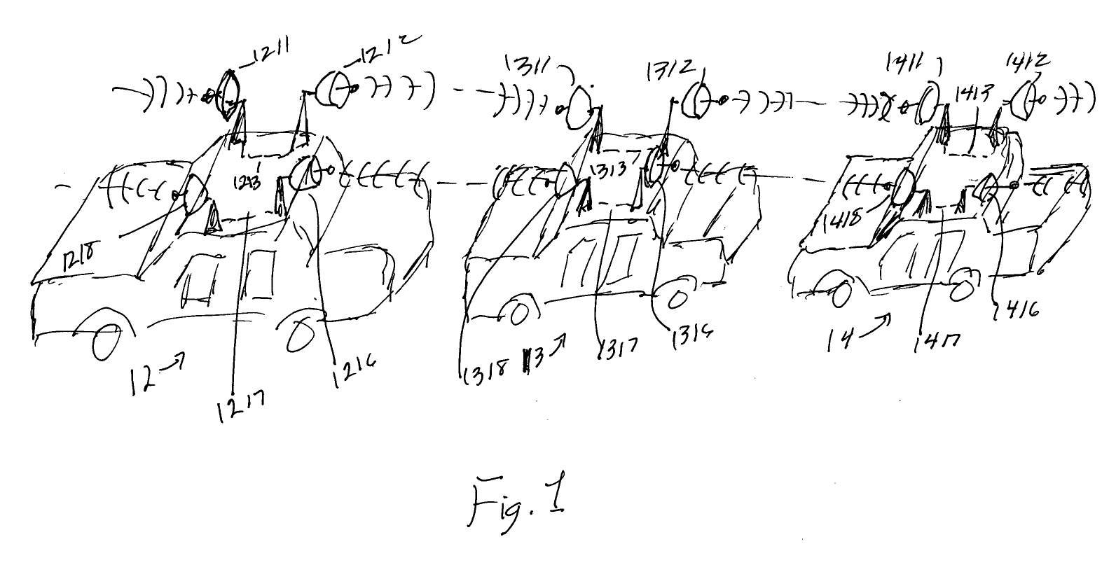

Referring to FIG. 1, the general configuration of the inter-vehicle communication system is shown according to the present invention. Vehicles 12, 13, and 14 represent consecutive vehicles in a traffic lane. Receiving unit 1211 on vehicle 12, receiving unit 1311 on vehicle 13, and receiving unit 1411 on vehicle 14 receive signals directed to the front of the signal-receiving vehicle. Transmitting unit 1212 on vehicle 12 coupled to receiving unit by conducting path 1213, transmitting unit. 1312 on vehicle 13 coupled to receiving unit 1311 by conducting path 1313, and transmitting unit 1412 on vehicle 14 coupled to receiving unit 1412 by conducting path 1413 transmit away from the vehicle the signal received by the receiving unit coupled by the conducting path. Similarly, receiving unit 1416 on vehicle 14 receives signals generated from the rear of the vehicle 14. These signals are coupled to the transmitting unit 1418 by conducting path 1417. The coupled signals are transmitted to vehicle 13 in front of vehicle 14. The receiving unit 1315 on vehicle 13 receives the signals transmitted from vehicle 14 and applies these signals by means of conducting path 1317 to the transmitting unit 1318. Transmitting unit 1318 transmits the signals to the receiving unit 1216 of vehicle 12. The signals received by receiving unit 1216 are applied through conducting path 1217 to transmitting unit 1218. Transmitting unit 1218 then transmits the signals to the next vehicle.

The foregoing description is meant to provide a broad outline of the operation of the present invention. As will be clear to those skilled in the art of transmitting and receiving electromagnetic signals, many antenna elements can be combined. In addition, for purposes of explanation, the antennas have been placed on the roofs of the vehicles. The antennas can be placed on the position of the automobile for most effective inter-vehicle communication. In addition, as the headlights and taillights of vehicles are implemented with light-emitting diodes (LEDs), the signals transmitted between vehicles can be imposed on the LED radiation.

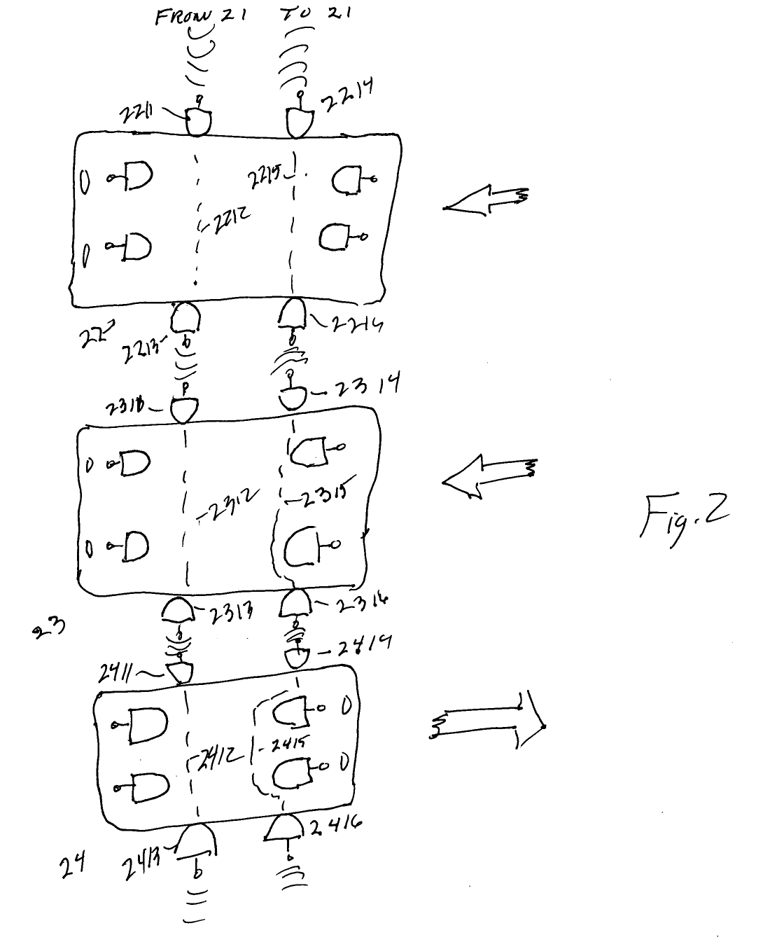

Referring to FIG. 2, an extended configuration for inter-vehicle communication is shown. In this configuration, the signal packets can be exchanged between vehicles in parallel lanes. In this configuration, the receiving unit and the associated transmitting unit are positioned on opposite sides of the vehicle. In FIG. 2, vehicle 22 includes receiving unit 2211 and an associated transmitting unit 2213 coupled by a conducting path 2212. This configuration transmits a signal from a vehicle 21 on one side of vehicle 22 to a vehicle 23 on the opposite side. Similarly, receiving unit 2216 and associated transmitting unit 2214 (coupled by conducting path 2215) transmit signals in the opposite direction, i.e., from vehicle 23 to vehicle 21. Vehicles 23 and 24 similarly include coupled receiving and transmitting units. Because both a receiving unit and a transmitting unit are on each side of a vehicle, the relative directions of the two vehicles in the parallel lanes does not effect the operation.

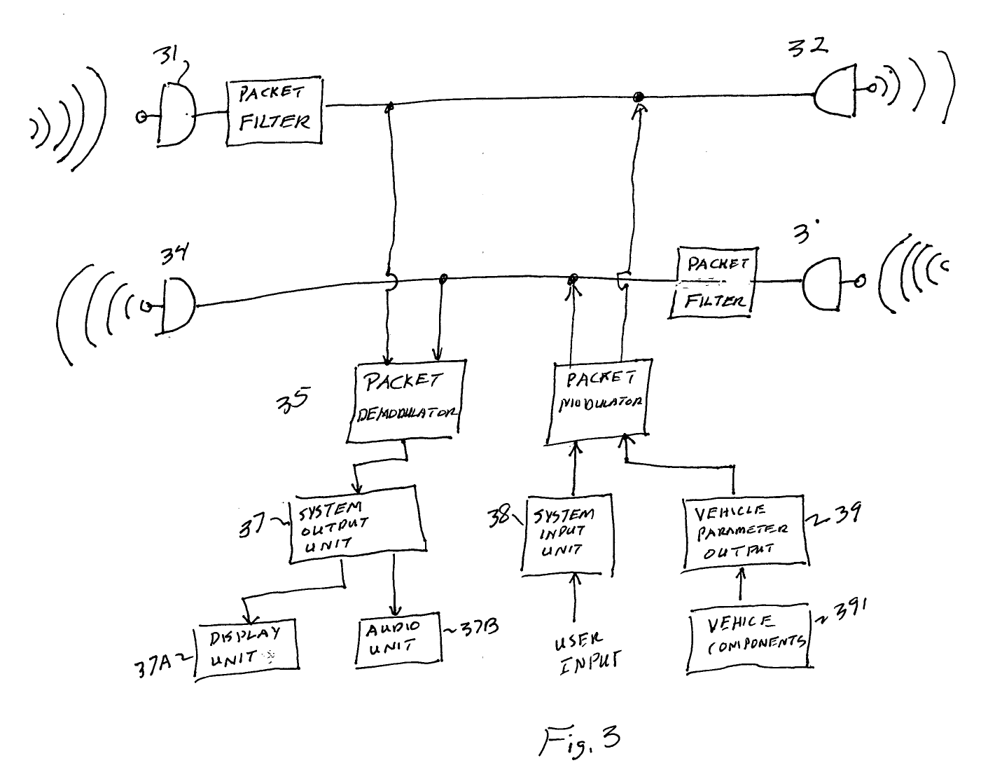

Referring to FIG. 3, a block diagram of the components of the inter-vehicle communication system according to the present invention is shown. The receiver unit 31 receives a signal packet directed in a first direction and applies this packet to a transmitting unit 32 transmitting the signal packet in the first direction. The receiving unit 33 receives a signal packet directed in the opposite direction and applies this signal packet to the transmitting unit 34 for transmission in the opposite direction. Packet filter 31A, associated with receiving unit 31 and packet filter 33A associated with receiving unit 33 remove duplicate signal packets. (As will be clear from FIG. 2A and FIG. 2B, situations exist in which the same signal packet can be applied to a receiving unit on more than one occasion. The packet filters suppress duplicate signal packets.) The signal packets on both packet signal conducting paths are applied to packet demodulator. After demodulation, the resulting signals are applied to the system output unit 37. The system output unit 37 determines whether a signal packet should be communicated to the (vehicle) user. Typically, this communication would be through a display unit 37A or an audio unit 37B. The (vehicle) user can provide inputs the system input unit 38 and the monitored vehicle components 391 provide signals to the vehicle parameter output unit 39. When the signals are such that other vehicles should be notified, signals from the system input unit 38 and/or from the vehicle parameter output unit 39 are applied to the output unit wherein the signal packets are formed and transmitted by the signal transmitting unit 32 and the signal transmitting unit 34.

### 2. OPERATION OF THE PREFERRED EMBODIMENT

The inter-vehicle communication system is designed as an additional tool to alert the drivers of vehicles to situations that may require their attention. The identification of the existing/pending situations can be provided by vehicle sensors and from the vehicle user input system. The vehicle user can identify anomalous or dangerous situations and enter the proper information into the user input device. However, it is possible to enter certain data from the vehicle itself into the inter-vehicle communication system. For example, when a vehicle begins rapid deceleration, the following vehicles can be alerted that an emergency (crash) stop may be required. The need for such a stop can be communicated to the traffic lane vehicle so that a less dramatic deceleration can be initiated by following vehicles. Similarly, hazardous conditions such a fog, dust storms, black ice, etc the severity of which may not be immediately obvious from a distance, can be communicated to following vehicles.

The inter-vehicle communication system can be implemented using receiving/transmitting arrays located on the roof of the vehicle, on the interior of the car, or on appropriate body locations. As LED (light-emitting diode) devices become common-place for vehicle lighting systems, the receiving and transmitting of signals can be accomplished by LED headlights and LED taillights and associated apparatus. One problem that should be considered is the effect of an accident on the integrity of the vehicle arrays.

The implementation shown in FIG. 3 has been designed to emphasize certain characteristics of the system. Other implementations are possible. For example, the processing of the signal packets can be centralized, such as when all incoming signals are processed by a central processing unit. Such a configuration would eliminate the need for positioning the packet filters near the receiving units.

As will be clear, the interface between the (vehicle) user and the inter-vehicle communication system has several requirements. Important among these is to minimize the distraction to the vehicle user. Similarly, some arrangement, such as audio loudness, should be present to alert the vehicle user of the relative severity of the incident to which he is being alerted.

As implied by the foregoing discussion, the information transmitted over the inter-vehicle communication system would probably need to be arranged in packets. In this manner, a packet header can be used to determine whether the received packet is a duplicate of a previously received packet and therefore eliminated from further transmission.

In the Figures, the receiving and transmitting units are shown as parabolic antennas. This selection permits the direction of the radiation flow to be illustrated. In actual implementation, the receiving unit and the transmitting unit can be combined. As indicated above, the modulation providing the signal packets can be imposed on the head lights, the tail lights and the side (running) lights.

The present inter-vehicle communication system also provides support for emergency vehicles. Frequently, the emergency vehicles must make their way up a line of traffic. The present invention permits the emergency vehicle to alert traffic of the impending need to permit the emergency vehicle to pass. With sufficient system sophistication, the system can alert the vehicle drivers to a suggested response for accommodating the emergency vehicle.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A vehicle communication system, the system comprising:
a first signal receiving unit receiving signals applied to the front of a vehicle;
a first signal generating unit generating signals at the rear of the vehicle, the first signal receiving unit coupled to the first signal generating unit, the first signal generating unit and first signal receiving unit transmitting a data signal received by the front of the vehicle to the rear of the vehicle for transmission.

2. The system as recited in claim 1 further comprising:
a second signal receiving unit receiving signals at the rear of the vehicle;
a second signal generating unit generating signals from the front of the vehicle, the second signal receiving unit coupled to the second signal generating unit, the second signal generating unit and second signal receiving unit transmitting a data signal received at the rear of the vehicle from front of the vehicle.

3. The system as recited in claim 1 further comprising an interface unit, wherein the first and the second signal receiving unit and the first and second signal generating unit are coupled to the interface unit.

4. The system of claim 3 wherein the interface unit can receive signals for transmission from at least one of a user or a vehicle component.

5. The system of claim 3 wherein the user interface unit provides a vehicle user with information about traffic conditions.

6. The system as recited in claim 2 further comprising a third and fourth signal receiving unit and a third and fourth signal generating unit coupled respectively to the receiving unit for transmitting signals to vehicles traveling parallel to the vehicle with the components.

7. A vehicle inter-communication system for communication between vehicles, the system comprising:
a plurality of vehicles, each vehicle including:
a first transmission unit, the first transmission unit receiving signals directed at a front of a vehicle and transmitting the signals directed away from the rear of the vehicle;
a second transmission unit, the second transmission unit receiving signals directed at the rear of the vehicle and transmitting signals directed away from the front of the vehicle; and
an interface coupled to the first and second transmission unit, the interface unit communicating to a user of the vehicle the information contained in the signals.

8. The system as recited in claim 7 further comprising:
a third transmission unit, the third transmission unit receiving signals on a first side of the vehicle and transmitting signals on a second side of the vehicle, and
a fourth transmission unit for receiving signals on the second side of the vehicle and transmitting signals from the first side of the vehicle.

9. The system as recited in claim 7 wherein the information is traffic information.

10. The system as recited in claim 7 wherein the interface unit receives information for transmission from at least one of the vehicle user and vehicle components.

11. The system as recited in claim 7 wherein the interface unit removes redundant information from the inter-vehicle communication system.

12. A method of communication between vehicles, the method comprising;
receiving status signals from a vehicle in front of a user vehicle;
transmitting the status signals to a vehicle behind user vehicle;
in response to preselected status signals, identifying a situation causing the status signals to the user.

13. The method as recited in claim 12 further comprising;
receiving status signals from a vehicle in the rear of the user vehicle; and
transmitting the status signals to a vehicle in front of the user vehicle.

14. The method as recited in claim 12 further comprising transmitting the status signals to and from vehicles traveling in a different lane in a direction parallel to the user vehicle.

15. The method as recited in claim 12 further comprising generating status signals in the user vehicle by a user input.

16. The method as recited in claim 12 further comprising generating status signals in the user vehicle in response to preselected user vehicle conditions.
